(19) United States
(12) Patent Application Publication
(10) Pub. No.: US 2005/0250585 A1
(43) Pub. Date: Nov. 10, 2005

(54) Propeller shaft and method of installing the same

(76) Inventor: Jason T. Curi, Auburn Hills, MI (US)

Correspondence Address: GKN DRIVELINE NORTH AMERICA, INC, 3300 UNIVERSITY DRIVE, AUBURN HILLS, MI, 48326, US

(21) Appl. No.: 10/841,089

(22) Filed: May 6, 2004

(51) Int. Cl. F16D 3/16

(52) U.S. Cl. 464/146

(57) ABSTRACT

A propeller shaft for use in a motor vehicle having an in vehicle installation error proofing method includes a fixed constant velocity joint on one end of the shaft, a plunging constant velocity joint on the opposite end of the shaft. The plunging constant velocity joint having a mechanical stop to prevent backwards installation of the shaft in the vehicle driveline.

### BACKGROUND OF THE INVENTION

1. Field of the Invention

The present invention generally relates to a power transfer system for a motor vehicle, and more particularly, relates to an improved propeller shaft having an in vehicle installation error proofing method to ensure proper installation of the propeller shaft in the vehicle drive line.

2. Description of Related Art

There are generally four main types of automotive drive line systems. More specifically, there exists a full time front wheel drive system, a full time rear wheel drive system, a part time four wheel drive system, and an all wheel drive system. Most commonly, the systems are distinguished by the delivery of power to different combinations of drive wheels, i.e., front drive wheels, rear drive wheels, or some combination thereof. In addition to delivering power to a particular combination of drive wheels, most drive systems permit the respectively driven wheels to rotate at different speeds. For example, the outside wheels must rotate faster than the inside drive wheels, and the front drive wheels must normally rotate faster than the rear wheels.

Drive line systems also include one or more Cardan (universal) and constant velocity joints (CVJ's). Cardan joints are the most basic and common type joint used for example, in prop shafts. Although highly durable, Cardan joints are typically not suited for applications with high angles (e.g., greater than 2 degrees) because of their inability to accommodate constant velocity rotary motion. Constant velocity joints, in contrast, are well known in the art and are employed where transmission of a constant velocity rotary motion is desired or required. For example, a tripod joint is characterized by a bell shaped outer race (housing) disposed around an inner spider joint which travels in channels formed in the outer race. This spider shape cross section of the inner joint is descriptive of the three equal spaced arms extending therefrom which travel on the tracks of the outer joint. Part spherical rollers are featured on each arm.

One type of constant velocity universal joint is a plunging tripod type, characterized by the performance of end motion in the joint. Plunging tripod joints are currently the most widely used in board (transmission side) joint in front wheel drive wheels, and particularly in the prop shafts found in rear wheel drive, all wheel drive and four wheel drive vehicles. A common feature of tripod universal joints is their plunging or end motion character. Plunging tripod universal joints allow the interconnection shafts to change length during operation without the use of splines which provoke significant reaction forces thereby resulting in a source of vibration and noise. Other common types of constant velocity joints are the plunging VL or cross groove type joint which consists of an outer race and inner race drivably connected through balls located in circumferentially spaced straight or helical grooves alternately inclined relative to a rotational axis. A high speed fixed joint is another type of constant velocity well known in the art and used where transmission of high speed is required. The disc style constant velocity fixed joint is another type of joint known in the prior art. This joint has an outer joint member open on both ends and a cage is assembled from the end opposite the end towards which the cage is urged by the ball expulsion forces under articulated load conditions. The prior art also includes a mono block constant velocity fixed joint also known as a mono block high speed fixed joint. The outer joint part is a bell shaped member having a closed end.

Drive line systems also include one or more ball spline joints which include a plurality of balls enclosed within a cage to permit rotation around inner and outer respective races. Like constant velocity joints, ball spline joints are adapted to accommodate plunge in the axial direction, i.e., end wise movement. However, unlike constant velocity joints, ball spline joints do not permit articulation at angle.

A typical drive line system incorporates one or more of the above joints in an all wheel drive or traditional four wheel drive system. In an all wheel drive systems, such joints are used to connect a pair of propeller shafts to a power take off unit and a rear driveline module, respectively. These propeller shafts function to transfer torque to the rear axle in rear wheel and all wheel drive vehicles. Similarly, in a traditional four wheel drive system, such joints are used to connect a propeller shaft between a transfer case and a front axle.

In the prior art there have been problems with the insertion and installation of a propeller shaft having a high speed fixed joint on one end and a VL plunging joint on the opposite end. The problem occurs when the shaft is installed into the vehicle backwards because both the high speed fixed joint and the VL plunging joint have the same outer diameter and bolt PCD. If the shaft is installed in the vehicle backwards, it may lead to damage of the VL plunging joint or the high speed fixed joint. Furthermore, the driveline system will not operate as designed if the prop shaft is installed backwards.

Therefore, there is a need in the art to provide a propeller shaft having an in vehicle installation error proofing method to insure that the prop shafts are installed in the correctly aligned position within the driveline of the automotive vehicle. There also is a need in the art for an improved cover, including a mechanical stop to ensure proper installation of the prop shaft within the driveline of the automotive vehicle.

### SUMMYAR OF THE INVENTION

One object of the present invention is to provide an improved drive shaft for use in a motor vehicle.

Another object of the present invention is to provide an improved constant velocity joint for use in a prop shaft of an automotive vehicle.

It is still another object of the present invention to provide a constant velocity joint having a mechanical stop to prevent the constant velocity joint and prop shaft from being installed backwards in the driveline of a vehicle.

It is still another object of the present invention to provide an improved flange for use in a prop shaft of an automotive vehicle.

To achieve the foregoing objects a propeller shaft for use in a vehicle is disclosed. The propeller shaft includes a fixed constant velocity joint for use on one end of the shaft. The propeller shaft includes a plunging constant velocity joint on an opposite end of the shaft with one of the constant velocity joints having a mechanical stop to prevent backwards installation of the shaft within the vehicle.

One advantage of the present invention is that it provides an improved prop shaft.

Still another advantage of the present invention is that provides a propeller shaft with an in vehicle installation error proofing method.

Yet a further advantage of the present invention is that it provides an improved constant velocity joint for use with a prop shaft.

Yet another advantage of the present invention is the use of a mechanical stop with a constant velocity joint to prevent backwards installation of a prop shaft in an automotive vehicle.

Still another advantage of the present invention is a modified flange to cooperate and engage with modified grease cover of a constant velocity joint to allow proper installation of a prop shaft in an automotive vehicle.

Other objects, features and advantages of the present invention may become apparent from the subsequent description, taken in conjunction with the accompanying drawings.

### BRIEF DESCRIPTION OF THE DRWAINGS

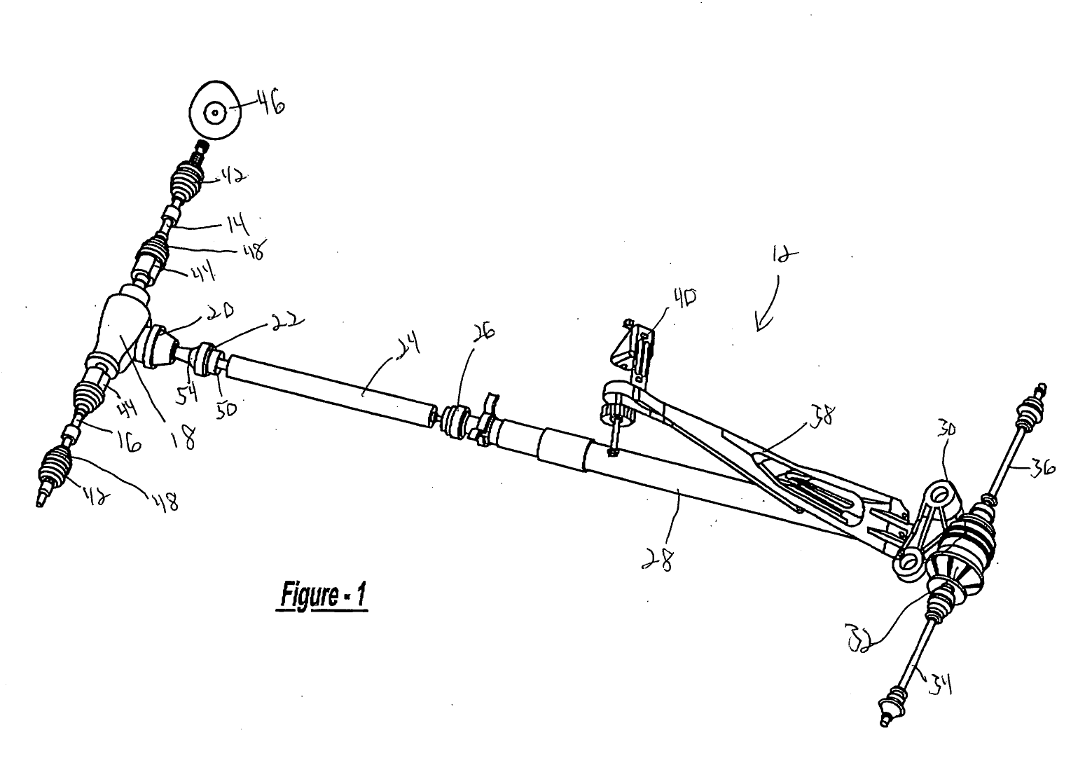

FIG. 1 is a perspective view of a representative all wheel drive system which may be adapted or receive the improved joint assembly of the present invention.

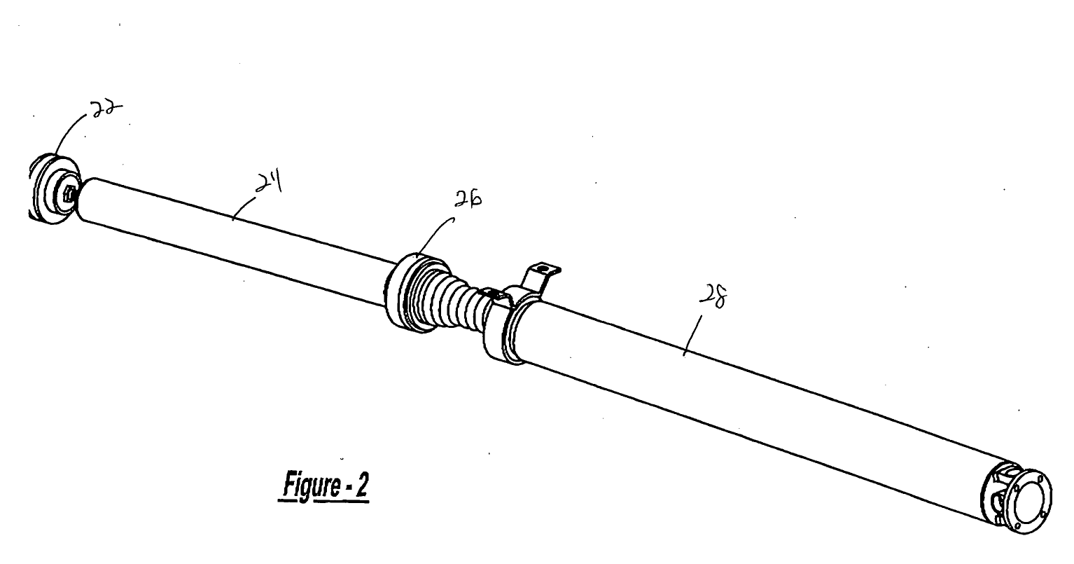

FIG. 2 is a perspective view of a prop shaft according to the present invention.

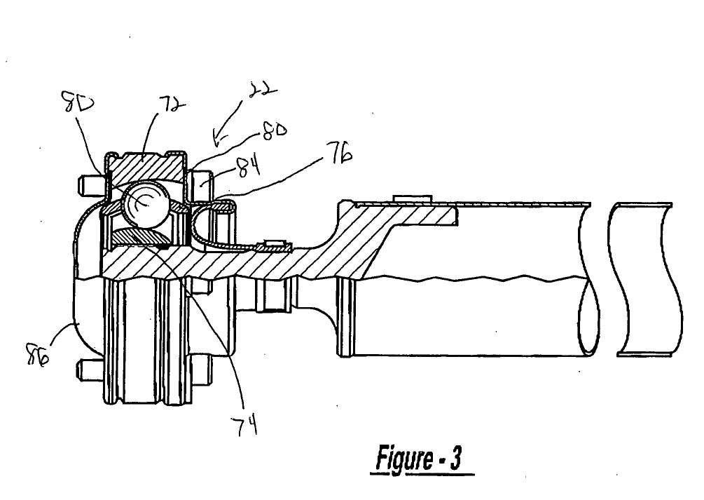

FIG. 3 is a partial cross section of a prop shaft and constant velocity joint according to the present invention.

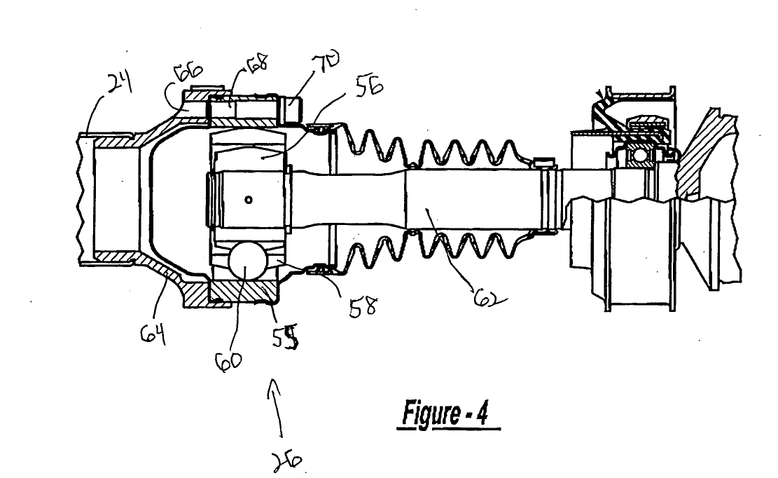

FIG. 4 is a cross section of a constant velocity joint and prop shaft according to the present invention.

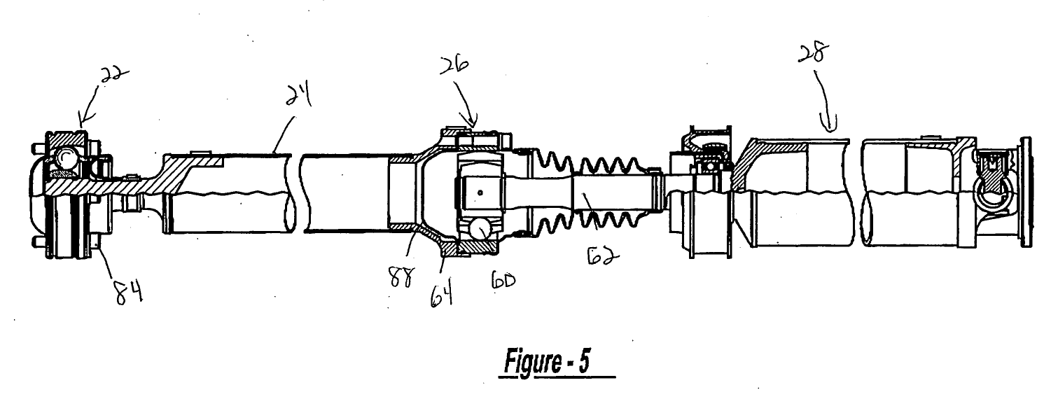

FIG. 5 is a partial cross section of a prop shaft according to the present invention.

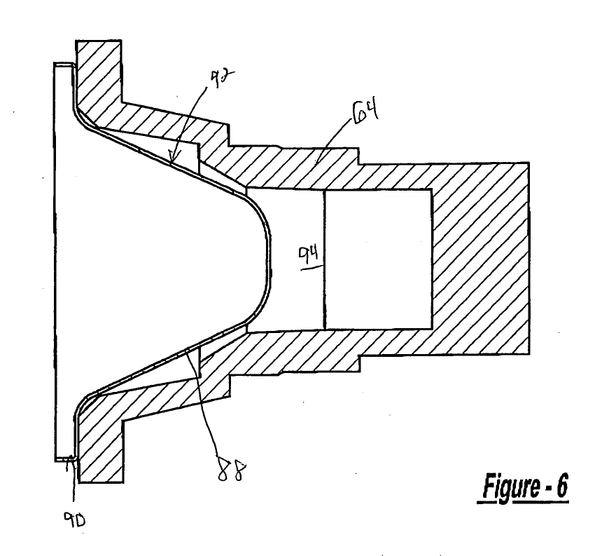

FIG. 6 is a cross section of a flange and cover according to the present invention.

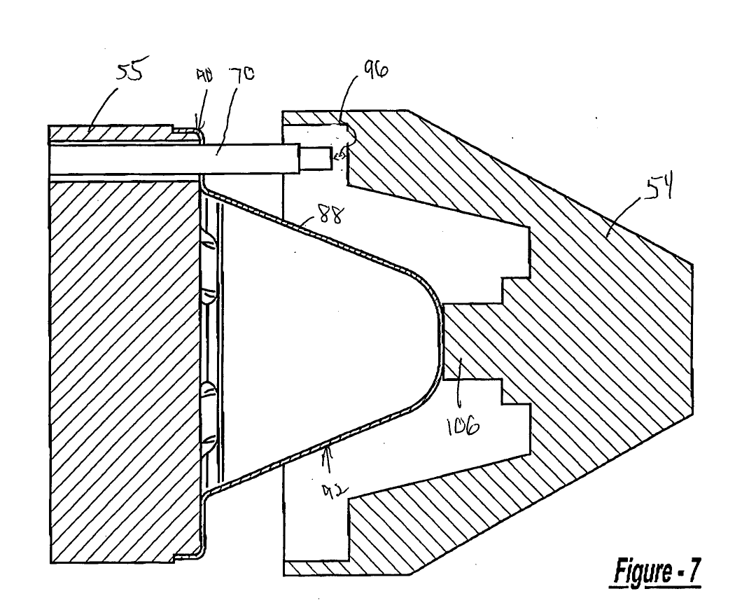

FIG. 7 is a cross section of a flange and improved cover according to the present invention.

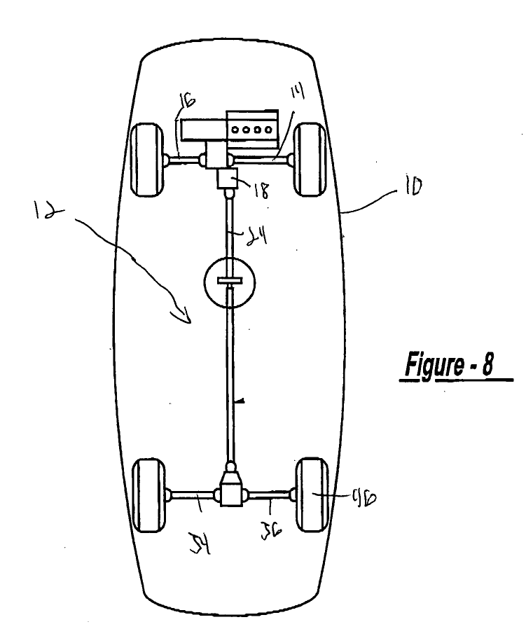

FIG. 8 is a diagrammatical depiction of a drive system according to the present invention.

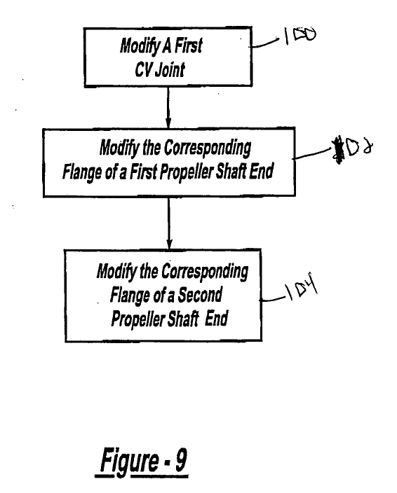

FIG. 9 is a flow chart showing a methodology of installation according to the present invention.

### DESCRIPTION OF EMBODIMENT(S)

Referring to the drawings, there is shown generally a representative diagram of an operative wheel drive system 12 of a motor vehicle 10. The drive system 12 comprises a pair of front half shaft assemblies 14, 16. The front half shaft assemblies 14, 16 are connected to a front differential 18. Connected to front differential 18 is a power take off unit 20. The power take off unit 20 is operatively connected to a high speed fixed joint 22. Operatively connected to the high speed fixed joint 22 is a front propeller shaft assembly 24. Operatively connected to front prop shaft assembly 24 is a VL style plunging constant velocity joint designated as reference numeral 26. Connected to the VL style constant velocity joint 26 is a rear prop shaft assembly 28. The rear prop shaft assembly 28 is connected on one end to a Cardan joint assembly. The Cardan joint assembly may be operatively connected to a speed sensing torque device 30. The speed sensing torque transfer device 36 is operatively connected to a rear differential assembly 32. A pair of rear half shaft assemblies 34, 36 are each connected to the rear differential assembly 32. As shown in FIG. 1, attached to the rear differential assembly 32, is a torque arm 38. The torque arm 38 is further connected to a torque arm mount 40.

The front half shaft assemblies 14, 16 are comprised of fixed constant velocity joints 42, and an interconnecting shaft in a plunging style constant velocity joint 44. The plunging style constant velocity joints 44 are operatively connected to the front differential 18. The plunging style constant velocity joints 44 are plug in style in this embodiment. However, any style of constant velocity joint half shaft assembly, may be used depending upon the application. As shown in FIG. 1 the stem portion is splined such that it interacts with a front wheel 46 of a motor vehicle and has a threaded portion which also connects the wheel 46 to the half shaft assembly. As shown in FIG. 1 the constant velocity joint boots 48 which are known in the art and are utilized to contain constant velocity joint lubricant, which generally is grease, within the constant velocity joint to keep the constant velocity joints lubricated for life.

The power take off unit 20 is mounted to the face of the transmission and receives torque from the front differential 18. The transmission is operatively connected to the engine of the motor vehicle. The power take off unit 18 has the same gear ratio as the rear differential 32 and drives the front prop shaft through the high speed fixed joint 22 from the front differential axis.

A high speed fixed joint 22 is connected at one end of the power take off unit 18 and at the other end to a front prop shaft 24. A VL type plunging constant velocity joint 26 is similarly connected at one end to the rear prop shaft 28 and at the other end to front prop shaft 24. The high speed fixed joint 22 may have a revolution per minute capacity of 6000 RPM's with the preferable range of three to five thousand RPM's, a torque capacity of five to fifteen hundred Newton meters, but the preferred capacity of six to seven hundred Newton meters and an inner capacity of up to 15 degrees with a preferable capacity of three to six degrees. Of course, the drive system may use other constant velocity joints and/or Cardan joints or universal joint technology at this connection. However, a high speed fixed joint is preferred.

The high speed fixed joint 22 includes a boot 50 which is utilized to enclose grease (not shown) required for lubrication of the high speed fixed joint 22. The front prop shaft 24 in the present invention is manufactured from steel providing a very low run up and critical high speed capacity higher than the second engine order. The front prop shaft 24 is operatively connected to the high speed constant velocity joint 22 by fasteners 52. The front prop shaft 24 has a flange 54 extending out which is connected to a constant velocity joint by the fasteners. The high speed fixed joint similarly includes a flange 54 extending out which is connected to the front prop shaft 24 by fasteners 52.

On the opposite end of the front propeller shaft 24 is a plunging VL constant velocity joint 26. The plunging VL constant velocity joint 26 includes an outer race 55 with an inner race 56 arranged within the outer race 55. The plunging constant velocity joint 26 also includes a cage 58 for supporting and locating a plurality of rolling elements 60 between an inner surface of the outer race 55 and an outer surface of the inner race 56. The plunging constant velocity joint 26 has a stub shaft 62 rotatably fixed to an inner bore of the inner race 56. The plunging VL constant velocity joint 26 also includes a flange 64 with the flange 64 connected to one end of the front prop shaft 24 and to the outer race 55 of the VL plunging constant velocity joint 26 on an opposite end thereof. The flange 64 has a plurality of orifices 66 therein that will align with the plurality of orifices 68 through a surface of the outer race 55 of the VL plunging constant velocity joint 26 and allow for fasteners 70 to secure the VL plunging constant velocity joint 26 to the flange 64 and hence the front prop shaft 24 of the automotive vehicle.

The high speed fixed constant velocity joint 22 as described above is located on the front end of the propeller shaft 24. The high speed fixed constant velocity joint 22 includes an outer race 72 with an inner race 74 arranged therein. A cage 76 and a plurality of rolling elements 78 are arranged between the inner race 74 and outer race 72 for transfer of constant velocity rotary motion through the high speed fixed joint 22. The high speed fixed constant velocity joint 22 includes a flange 54 that is connected to the power take off unit 18 on one end and to the outer race 72 of the high speed constant velocity joint 22 on the opposite end. The outer race 72 of the constant velocity joint 22 has a plurality of orifices 80 therethrough that mate with and align with a plurality of orifices through the flange 54 of the high speed constant velocity joint 22. Fasteners 84 will connect the high speed constant velocity joint 22 to the flange 54 during installation of the constant velocity joint.

The high speed constant velocity joint 22 includes a grease cap 86 on one end thereof. The plunging VL constant velocity joint 26 also includes a grease cover 88 in contact with the outer race 55 and flange 64 of the VL constant velocity joint 26. The grease covers 86, 88 will ensure the lubricant stays within the VL plunging constant velocity joint 26 and the high speed fixed joint 22 for proper lubrication of the joints. According to the present invention the VL plunging constant velocity joint 26 has a modified grease cover 88 arranged to any known caps in the prior art. In particular, as shown in FIGS. 6 and 7 the grease cover or cap 88 will have a generally U-shaped cross section. The grease cover or cap 88 will also have a circumferential lip 90 generally having an L-shaped cross section at one end thereof. The U-shaped grease cover 88 will have an extended or lengthened body 92 as shown. This extended or lengthened body 92 will have a predetermined depth which will penetrate into a bore 94 of the flange 64 of the VL plunging joint 26. It should be noted that the improved grease cover 88 is currently made of a metal material, however any hard plastic, composite, ceramic or the like material may also be used. The bell portion or body 92 of the U-shaped improved grease cover 88 will be lengthened a predetermined distance such that if the prop shaft 24 is mistakenly installed backwards into the vehicle the lengthened grease cover 88 will prevent installation of the plunging constant velocity joint 26 into the high speed fixed joint flange 54 via a mechanical stop as shown in FIG. 7. In an embodiment contemplated the incorrect installation of the prop shaft 24 will leave a minimum of a five millimeter gap 96 between the end of a fastener 70 of the plunging constant velocity joint 26 and a threaded orifice of the high speed fixed joint flange 54. This will ensure that the installer of the prop shaft 24 into the vehicle drive line of the automotive vehicle, cannot torque and secure the prop shaft 24 backwards within the drive line environment.

As shown in FIG. 6 the present invention also includes a modified plunging VL flange 64 for use with the modified and lengthened grease cover 88 for the plunging VL type joint 26. The modified flange 64 includes an increased sized bore 94 that has been lengthened and widened to allow entry and mating with the lengthened grease cover 88 of the VL plunging joint 26. As shown in FIG. 6 during proper installation of the prop shaft 24 the improved grease cover 88 will mate with an be allowed to be inserted within the expanded, in both a width and length direction, flange inner bore 94. The grease cover 88 after proper installation will be in contact at the lip 90 with a surface of the VL plunging style flange 64 and the outer race 55 of the VL plunging style joint 26. Therefore, with proper installation of the VL plunging joint 26 to the VL plunging flange 64 the fasteners 70 will be capable of being properly tightened while the fasteners 84 for the high speed fixed joint 22 will be capable of being properly tightened and secured to the high speed fixed joint flange 54 located at the front end of the front prop shaft 24. It should be noted that the modified VL plunging flange 54 is preferably made of a steel material, however any other metal, hard plastic, composite, or the like may also be used depending on the design requirements of the drive line. It should be noted that it has been contemplated to leave a five millimeter gap 96 between the end of the fastener 70 and the threaded orifice of the high speed fixed joint flange 54 however any other gap size may also be used depending on the design requirements and packaging requirements of the driveline. The modified grease cover 88 of the VL plunging constant velocity joint 26 will ensure that the fasteners are not tightened down and thus damage or crush the grease cover 88, as happened sometimes with the prior art arrangement. The extended grease cover 88 for the VL plunging constant velocity joint 22, expanded inner bore 94 for the VL flange 64 and flange 54 together or in any combination provide a mechanical stop which will keep any installer from installing the prop shaft 24 backwards in the automotive vehicle driveline. Other contemplated embodiments are capable for the mechanical stop to create an in vehicle installation error proofing method for installation of a propeller shaft having common joint ends. It should be noted that the grease cover 88 in the embodiment shown has a length that ensures that if the prop shaft 24 is installed improperly into the high speed fixed joint flange 54 it would create the five millimeter gap to ensure no tightening of the VL joint 25 with respect to the flange 54. Therefore, any size grease cover 88 and any size inner bore 94 for a flange 64 may be designed to create specific mechanical stop features for different prop shafts in vehicle drivelines.

As shown in FIG. 7 the second flange 54 may have an extension or knob 106 arranged at a center point or other portion of the high speed fixed constant velocity joint flange 54. It should be noted that the original high speed fixed joint flange 54 may be designed such that installation of the modified VL plunging cover 88 is not even possible. However, it is contemplated to put an extension 106 into the inner bore of the high speed constant velocity joint flange 54 to ensure a mechanical stop occurs thus ensuring the prop shaft 24cannot be installed backwards within the motor vehicle driveline. Therefore, modification of the high speed fixed joint flange 54 is also possible in the present invention.

FIG. 9 shows one methodology for insuring error proof installation of a prop shaft 24 in a motor vehicle driveline. Box 100 shows the modifying of a first constant velocity joint 26 along with the modifying of a corresponding flange 64 in box 102 of the first propeller shaft 24 end of the automotive vehicle driveline. Next there will be a modifying of the corresponding flange 54 of a second propeller shaft end of the propeller shaft 24 such that the modified first constant velocity joint 26 is not capable of being inserted into the second flange 54 of the second end of the prop shaft 24.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

1. A propeller shaft for use in a vehicle, said propeller shaft including:
a fixed constant velocity joint on one end of the shaft; and
a plunging constant velocity joint on an opposite end of the shaft, said plunging constant velocity joint having a mechanical stop to prevent backwards installation of the shaft.

2. The propeller shaft of claim 1 wherein said mechanical stop including a lengthened grease cover.

3. The propeller shaft of claim 2 wherein said grease cover having a generally U-shaped cross section.

4. The propeller shaft of claim 2 further including a flange having an increased bore therein to receive said grease cover.

5. The propeller shaft of claim 4 wherein said grease cover having a generally cone shape, said grease cover having a predetermined depth of said cone shape, said fixed constant velocity joint having a flange with a knob extending from an inner surface thereof.

6. A constant velocity joint for use in a propeller shaft of a vehicle, said joint including:
an outer race;
an inner race arranged within said outer race;
a flange connected to said outer race; and
a cover having a generally U-shaped cross section, said cover having a predetermined increased length, said cover extends into said flange.

7. The constant velocity joint of claim 6 wherein said flange having a predetermined shaped bore for receiving said cover.

8. The constant velocity joint of claim 7 wherein said bore being wider and deeper.

9. The constant velocity joint of claim 6 wherein said grease cover properly seats within said flange and will not properly seat within any other portion of the propeller shaft.

10. The constant velocity joint of claim 6 wherein the joint is a plunging type constant velocity joint.

11. The constant velocity joint of claim 6 wherein said cover having a circumferential lip on one end thereof.

12. The constant velocity joint of claim 11 wherein said lip having a plurality of orifices therein.

13. The constant velocity joint of claim 12 further including a plurality of fasteners for securing said flange to said outer race, said plurality of fasteners being arranged within said plurality of orifices.

14. A rotary shaft for use in a vehicle driveline, said shaft including:
a fixed constant velocity joint connected to a first end of the shaft;
a first flange secured to said fixed constant velocity joint;
a plunging constant velocity joint connected to a second end of the shaft;
a second flange secured to said plunging constant velocity joint; and
said plunging constant velocity joint having a mechanical stop that mates with said second flange, said mechanical stop prevents said plunging constant velocity joint from being inserted and secured to said first flange.

15. The shaft of claim 14 wherein said mechanical stop including a grease cover having a cone shaped body.

16. The shaft of claim 15 wherein said body having a predetermined length.

17. The shaft of claim 16 further including a circumferential lip extending from an end of said body.

18. The shaft of claim 17 wherein said lip contacts said plunging constant velocity joint and said second flange.

19. The shaft of claim 18 wherein said second flange having a predetermined inner bore for receiving and holding said grease cover.

20. The shaft of claim 19 wherein said mechanical stop having an interference condition when mated with said first flange, said interference condition creating a predetermined size gap between an end of a fastener and said first flange.

21. The shaft of claim 20 wherein said gap is approximately five mm.

22. A method of error proofing installation of a propeller shaft in a vehicle driveline, said method including the steps of:
modifying a first constant velocity joint;
modifying a first flange on a first end of the shaft;
connecting said first constant velocity joint to said first flange; and
connecting a second constant velocity joint to a second flange on a second end of the shaft.
